(19) United States
(12) Patent Application Publication
(10) Pub. No.: US 2020/0149128 A1
(43) Pub. Date: May 14, 2020

(54) METHOD FOR MANUFACTURING STEEL PLATES

(71) Applicant: TOYOTA JIDOSHA KABUSHIKI KAISHA, Toyota-shi (JP)

(72) Inventor: Tomoya SAKAI, Toyota-shi (JP)

(21) Appl. No.: 16/676,582

(22) Filed: Nov. 7, 2019

(30) Foreign Application Priority Data
Nov. 13, 2018 (JP) 2018-212680

(51) Int. Cl. C21D 9/46; C21D 9/00; B21B 27/02; C22C 38/04; C21D 8/02

(52) U.S. Cl. CPC C21D 9/46; C21D 9/0012; C21D 2211/001; C22C 38/04; C21D 8/0278; B21B 27/021

(57) ABSTRACT

Provided is a method for manufacturing a steel plate that includes plastic working as preliminary processing before press working and is capable of keeping the press formability of the steel plate after the preliminary processing. A method for manufacturing a steel plate used for press working, and the method includes: preparing a steel plate containing C: 0.03 to 0.50 mass % and Mn: 2.0 to 20 mass % and having a ratio of residual austenite in a metallographic structure that is 20 to 50 volume %; and plastic working at least a part of the prepared steel plate while heating the steel plate at 50° C. or higher for preliminary processing before press working.

### CROSS REFERENCE TO RELATED APPLICATIONS

The present application claims priority from Japanese patent application JP 2018-212680 filed on Nov. 13, 2018, the content of which is hereby incorporated by reference into this application.

### BACKGROUND

### Technical Field

The present disclosure relates to a method for manufacturing a steel plate used for press working.

### Background Art

Conventionally pressed components have been manufactured by press working of a blank, such as a steel plate. JP 2012-148305 A, for example, proposes a press-working method based on deformation-induced transformation to transform residual austenite into martensite during plastic working. This press-working method heats a steel material containing 5 volume % or more of residual austenite in the temperature range of 450 to 600° C. before press working so as to avoid cracks during the press working.

### SUMMARY

The method of JP 2012-148305 A may include preliminary processing of the steel plate by plastic working before the press working (main-forming). Such preliminary processing is plastic working, which deformation-induced transforms the residual austenite in the steel plate into martensite, and so degrades the press formability of the steel plate after the preliminary processing.

In view of this, the present disclosure provides a method for manufacturing a steel plate including plastic working as preliminary processing before press working and capable of keeping the press formability of the steel plate after the preliminary processing.

To solve the problem, a method for manufacturing a steel plate according to the present disclosure manufactures a steel plate used for press working. The method includes: preparing a steel plate containing C: 0.03 to 0.50 mass % and Mn: 2.0 to 20 mass % and having a ratio of residual austenite in a metallographic structure that is 20 to 50 volume %; and plastic working at least a part of the prepared steel plate while heating the steel plate at 50° C. or higher for preliminary processing before press working.

The method of the present disclosure plastically deforms at least a part of a steel plate while heating the steel plate having residual austenite as stated above at 50° C. or higher, and so prevents the residual austenite in the steel plate from transforming into the deformation-induced martensite. This keeps the residual austenite in the steel plate after preliminary processing, and so keeps press formability of the steel plate after preliminary processing.

If preliminary processing is performed while heating the steel plate at the temperature less than 50° C., the residual austenite transforms into deformation-induced martensite. In this case, the steel plate hardly keeps the residual austenite. This results in lowering of the press formability of the steel plate after preliminary processing.

The plastic working as stated above is not limited especially, which may be other types of machining, such as bending, rolling and cutting. In some embodiments, the plastic working for the preliminary processing rolls the prepared steel plate to have different plate thicknesses.

The thin part of the steel plate subjected to such rolling to have different plate thicknesses has a larger rolling reduction than the other part and so has a larger plastic strain. The thin part therefore normally generates a breakage easily during press working. Such a thin part also keeps the residual austenite, and so keeps the press formability.

The method of the present disclosure includes plastic working as preliminary processing before press working and is still capable of keeping the press formability of a steel plate after the preliminary processing.

### BRIEF DESCRIPTION OF THE DRAWINGS

FIG. 1 schematically shows a method for manufacturing a steel plate according to an embodiment of the present disclosure;

FIG. 2 is a graph showing the ratio of the residual austenite and the deformation-induced martensite in the test pieces of Example 1, Comparative Example 1 and Reference Example; and

FIG. 3 is a graph showing the breaking elongation of the test pieces of Examples 2 to 4 and Comparative Example 2.

### DETAILED DESCRIPTION

### 1. Method for manufacturing a Steel Plate

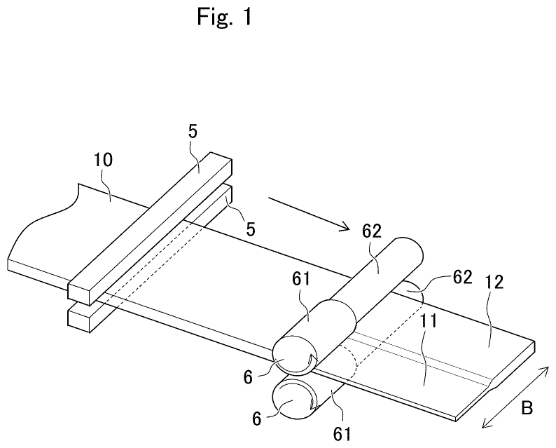

Referring to FIG. 1, the following describes the method for manufacturing a steel plate according to one embodiment of the present disclosure. FIG. 1 schematically shows the method for manufacturing a steel plate 10 according to one embodiment of the present disclosure.

1-1. Step to Prepare a Steel Plate

The present embodiment firstly prepares a steel plate 10 containing C (carbon): 0.03 to 0.50 mass % and Mn (manganese): 2.0 to 20 mass % and having the ratio of residual austenite in metallographic structure that is 20 to 50 volume %. The steel plate 10 may contain, in addition to these components, other elements, such as Si (silicon) and unavoidable impurities.

The steel plate 10 in the present embodiment is a plate having a uniform plate thickness. The steel plate 10 is a high tensile-strength steel plate, and the prepared steel plate has a metallographic structure containing ferrite as a parent phase and 20 to 50 volume % of residual austenite. Examples of such a high tensile-strength steel plate include generally known steel plates, such as TPIR steel and TWIP steel.

C: 0.03 to 0.50 Mass %

The present embodiment adds C to increase the strength of the steel plate (high tensile-strength steel plate). C in this range added to the steel plate keeps the strength and the ductility of the steel plate. Less than 0.03 mass % of C in the steel plate does not achieve sufficient strength of the steel plate, and C exceeding 0.50 mass % lowers the ductility of the steel plate.

Mn: 2.0 to 20 Mass %

The present embodiment adds Mn to increase the strength of the steel plate (high tensile-strength steel plate) and give residual austenite to the structure. Less than 2.0 mass % of Mn in the steel plate lowers residual austenite in the steel plate below the above-stated range, and Mn exceeding 20 mass % increases the residual austenite above the above-stated range.

Volume ratio of Residual Austenite: 20 to 50 Volume %

The steel plate of the present embodiment contains ferrite as a parent phase and residual austenite in the above-stated range. Press working described later transforms the residual austenite into martensite (deformation-induced martensite). The residual austenite in such a range can be obtained by adjusting a rolling condition or an annealing condition, for example.

If the residual austenite is less than 20 volume %, the amount of the residual austenite is too little. In such a case, the steel plate subjected to press forming after the preliminary processing described later will not have advantageous effects from the deformation-induced martensite. The residual austenite exceeding 50 volume % does not lead to better advantageous effects, and increases the material cost.

1-2. Step for Preliminary Processing

This step performs preliminary processing to the prepared steel plate before press working. Specifically this step heats the prepared steel plate 10 at a temperature of 50° C. or higher, and plastically deforms at least a part of the steel plate 10 for preliminary processing before the press working.

Specifically as shown in FIG. 1, this step feeds the prepared steel plate 10 into a pair of heating devices 5, 5 to heat the steel plate 10 to 50° C. or higher, preferably 100° C. or higher during rolling by the reduction rolls 6, 6 described later.

The heating devices 5 of the present embodiment are a high-frequency induction heater or an infrared heater, and they may be a heating furnace having a heat source, such as combustion gas or a heater, instead of the heating devices to heat the steel plate 10. The heating method is not limited especially as long as the temperature of the steel plate 10 during rolling satisfies the above-stated temperature range.

Next as shown in FIG. 1, the step plastically deforms a part of the steel plate 10 that is heated by the heating devices 5 at 50° C. or higher, preferably 100° C. or higher for preliminary processing before the press working.

Specifically the present embodiment feeds the steel plate 10 passing through the pair of heating devices 5 and 5 into a pair of reduction rolls 6 and 6. These reduction rolls 6 and 6 roll the steel plate 10 to be a blank having different plate thicknesses in the width direction B.

More specifically each of the reduction rolls 6 of the present embodiment is a stepped reduction roll having a large-diameter part 61 and a small-diameter part 62. A part of the steel plate 10 passing through the large-diameter parts 61 and 61 of the reduction rolls 6 has a larger rolling reduction than the other part because the part is rolled by the large-diameter parts 61 and 61, and this part is a thin part 11 that has a small thickness.

A part of the steel plate 10 passing through the small-diameter parts 62 and 62 of the reduction rolls 6 has a smaller rolling reduction than the part of the steel plate 10 passing through the large-diameter parts 61 and 61 because the part is rolled by the small-diameter parts 62 and 62, and this part is a thick part 12 that has a large thickness.

The present embodiment is configured so that the part of the steel plate 10 passing through the small-diameter parts 62 and 62 also is rolled, and this part may not be rolled. The present embodiment is configured so as to roll the steel plate 10 with the reduction rolls 6 each having the large-diameter part 61 and the small-diameter part 62. Each of the reduction rolls may have diameters (different diameters) in accordance with a desired plate-thickness distribution of the rolled steel plate 10 in the width direction B, and the steel plate 10 may be rolled with such reduction rolls.

After that, the rolled steel plate 10 through the preliminary processing is cut, and then press forming, such as cold press working, is performed to the cut steel plate 10 to have a desired shape. The present embodiment plastically deforms the steel plate 10 while heating the steel plate 10 having residual austenite as stated above at 50° C. or higher, and so prevents the residual austenite in the steel plate 10 from transforming into the deformation-induced martensite.

The thin part 11 of the steel plate 10 rolled with the reduction rolls 6 and 6 has a larger rolling reduction than the other part and so has a larger plastic strain. The thin part 11 therefore normally generates a breakage easily during press working. The present embodiment rolls the steel plate 10 while heating it at 50° C. or higher, and so keeps the residual austenite in the thin part 11 as well. The present embodiment therefore suppresses the lowering of press formability of the thin part 11.

In this way the present embodiment keeps the residual austenite in the steel plate 10 after preliminary processing, and so keeps press formability of the steel plate 10 after preliminary processing. If preliminary processing is performed while heating the steel plate 10 at the temperature less than 50° C., the residual austenite transforms into deformation-induced martensite, which is clear from the experiment by the present inventor as described later. In this case, the steel plate hardly keeps the austenite. This results in lowering of the press formability of the steel plate after preliminary processing.

### EXAMPLES

The following describes the present disclosure by way of Examples.

### Example 1

A test piece of a steel plate (high tensile-strength steel plate) having the components shown in Table 1 was prepared. This high tensile-strength steel plate had a metallographic structure containing ferrite as a parent phase and residual austenite (RA) in the ratio of Table 1. The ratio of the residual austenite in the metallographic structure of the steel plate was measured by X-ray diffractometry.

TABLE 1

| C | Si | Mn | P | S | RA |
|---|---|---|---|---|---|
| (mass %) | (mass %) | (mass %) | (mass %) | (mass %) | (volume %) |
| 0.14 | 0.47 | 4.93 | 0.018 | 0.001 | 35 |

Next a tensile test (plastic working) was conducted to this test piece in the heating environment at 100° C. This tensile test was to simulate the preliminary processing of the steel plate. Table 2 shows the result. The tensile test conformed to JIS Z 2241. The tensile direction of the test piece was the direction perpendicular to the rolling direction. The gauge length was 30.0 mm and the plate thickness was 1.4 mm.

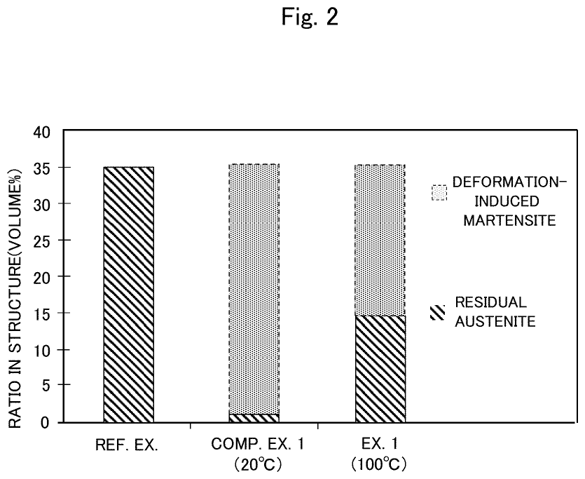

The ratio of the residual austenite and the deformation-induced martensite after break were measured by X-ray diffractometry. FIG. 2 shows the result. FIG. 2 also shows the ratio of the residual austenite in the test piece before tensile test for reference.

### Comparative Example 1

Similarly to Example 1, a test piece of Comparative Example 1 was prepared, and a tensile test was conducted to the test piece. Comparative Example 1 was different from Example 1 in that the tensile test was conducted in the heating environment at 20° C. Table 2 shows the result. The ratio of the residual austenite and the deformation-induced martensite after break was measured. FIG. 2 shows the result.

TABLE 2

| | tensile | | | | | |
|---|---|---|---|---|---|---|
| | test | yield | tensile | breaking | uniform | local |
| | temp. | stress | strength | elongation | elongation | elongation |
| | (° C.) | (MPa) | (MPa) | (%) | (%) | (%) |
| Ex.1 | 100 | 795 | 1020 | 36.0 | 31.0 | 5.0 |
| Comp. | 20 | 780 | 1250 | 22.0 | 18.5 | 3.5 |
| Ex.1 | | | | | | |

### Result 1

As shown in Table 2, the test piece of Example 1 had larger elongation, such as breaking elongation, and larger ductility than those of the test piece of Comparative Example 1. As shown in FIG. 2, while the test piece of Example 1 had about 15% of residual austenite, the test piece of Comparative Example 1 hardly had residual austenite. The residual austenite corresponding to the reduced ratio transformed into deformation-induced martensite through the tensile test. The above results show that heating as in Example 1 keeps the residual austenite.

### Examples 2 to 4

The test pieces of a steel plate (high tensile-strength steel plate) were prepared similarly to Example 1. Next a tensile test (plastic working) was conducted to these test pieces in the heating environment of 50° C. (Example 2), 100° C. (Example 3), and 200° C. (Example 4) to have 10% of pre-strain, and the test pieces were then cooled to room temperature. This tensile test was to simulate the preliminary processing of the steel plate.

### Comparative Example 2

The test piece of a steel plate (high tensile-strength steel plate) was prepared similarly to Examples 2 to 4. Comparative Example 2 was different from Examples 2 to 4 in that the tensile test (plastic working) was conducted in the heating environment at 20° C. to have 10% of pre-strain.

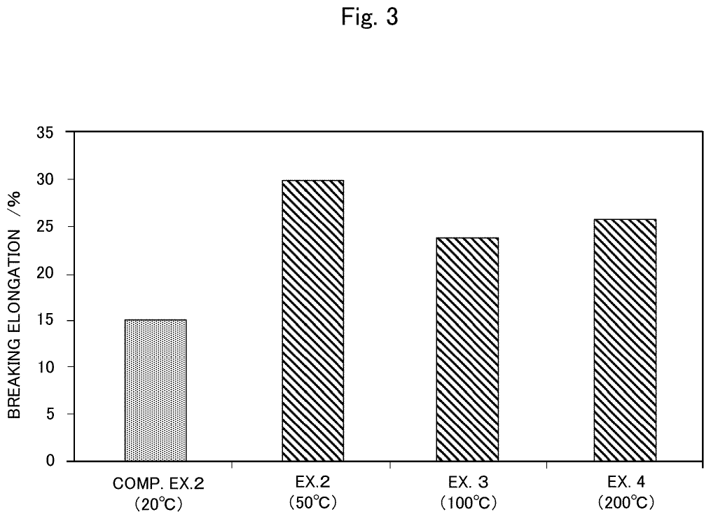

To simulate press working, a tensile test was conducted to the test pieces of Examples 2 to 4 and Comparative Example 2 in the heating environment at 20° C. until these test pieces broke. Table 3 and FIG. 3 show the result.

TABLE 3

| | temp. to give | tensile test | yield | tensile | breaking | uniform | local |
|---|---|---|---|---|---|---|---|
| | pre-strain | temp. | stress | strength | elongation | elongation | elongation |
| | (° C.) | (° C.) | (MPa) | (MPa) | (%) | (%) | (%) |
| Ex.2 | 50 | 20 | 925 | 1230 | 30.0 | 24.0 | 6.0 |
| Ex.3 | 100 | 20 | 840 | 1220 | 24.0 | 23.0 | 1.0 |
| Ex.4 | 200 | 20 | 900 | 1180 | 26.0 | 21.5 | 4.5 |
| Comp. | 20 | 20 | 1160 | 1250 | 15.0 | 14.0 | 1.0 |
| Ex.2 | | | | | | | |

### Result 2

As shown in FIG. 3 and Table 3, the test pieces of Examples 2 to 4 had improved breaking elongation than that of Comparative Example 2. The breaking elongation of the test pieces of Examples 2 to 4 improved by about 1.5 times to 2.0 times as compared with Comparative Example 2. This shows that the temperature at 50° C. or higher to give pre-strain to the test pieces of Examples 2 to 4 allows the residual austenite to remain, and this improved the ductility of the test pieces as compared with Comparative Example 2.

That is, preliminary processing of a steel plate before press working while heating the steel plate at 50° C. or higher suppresses the lowering of press formability of the steel plate during the press working.

That is a detailed description of the embodiments of the present disclosure. The present disclosure is not limited to the above-stated embodiment, and the design may be modified variously without departing from the spirits of the present disclosure.

The present embodiment describes rolling of a steel plate with reduction rolls as one example of the preliminary processing of a steel plate before press working. The preliminary processing may be other types of machining, such as bending and cutting.

### DESCRIPTION OF SYMBOLS

5 Heating device
6 Reduction roll
10 Steel plate
11 Thin part
12 Thick part

What is claimed is:

1. A method for manufacturing a steel plate used for press working, the method comprising:
preparing a steel plate containing C: 0.03 to 0.50 mass % and Mn: 2.0 to 20 mass % and having a ratio of residual austenite in a metallographic structure that is 20 to 50 volume %; and
plastic working at least a part of the prepared steel plate while heating the steel plate at 50° C. or higher for preliminary processing before press working.

2. The method for manufacturing the steel plate according to claim 1, wherein the plastic working for the preliminary processing rolls the prepared steel plate to have different plate thicknesses.
